(19) United States
(12) Patent Application Publication
(10) Pub. No.: US 2017/0126888 A1
(43) Pub. Date: May 4, 2017

(54) METHOD AND DEVICE FOR MAKING CALL

(71) Applicant: Xiaomi Inc., Beijing (CN)

(72) Inventors: Yueting LI, Beijing (CN); Xinyan XING, Beijing (CN); Xing YONG, Beijing (CN)

(73) Assignee: Xiaomi Inc., Beijing (CN)

(21) Appl. No.: 15/297,952

(22) Filed: Oct. 19, 2016

(30) Foreign Application Priority Data
Oct. 29, 2015 (CN) 201510719022.8

(51) Int. Cl. H04M 3/42; H04W 4/16; H04W 4/00; H04W 4/04; G07C 5/00

(52) U.S. Cl. CPC H04M 3/42374; H04W 4/046; G07C 5/008; H04W 4/008; H04M 3/42093; H04W 4/16

(57) ABSTRACT

The present disclosure relates to a method and a device for making a call. Aspects of the disclosure provide a method for communication. The method includes determining, at a terminal device, whether a user of the terminal device is in a vehicle-driving state, and when the user of the terminal device is in the vehicle-driving state, sending a first message to a server for the server to make the vehicle-driving state of the user noticeable to one or more contact persons of the user to avoid calling disturbance from the one or more contact persons.

### CROSS-REFERENCE TO RELATED APPLICATIONS

This application is based upon and claims priority to Chinese Patent Application No. 201510719022.8, filed Oct. 29, 2015, the entire contents of which are incorporated herein by reference.

### TECHNICAL FIELD

The present disclosure relates to the field of mobile communication, and more particularly, to a method and a device for making a call.

### BACKGROUND

With the development of science and technology, it is common to answer a call by using a terminal device (such as a mobile phone) in work and life of people. But sometimes, people may be inconvenient to answer the call for a variety of reasons, wherein a typical scenario is in a car, a ringtone may interfere with a driver and result in distraction, and if the call is answered, it is easy to cause traffic accidents.

### SUMMARY

The present disclosure provides a method and a device for making a call, to avoid the interference caused by the call to the driver.

Aspects of the disclosure provide a method for communication. The method includes determining, at a terminal device, whether a user of the terminal device is in a vehicle-driving state, and when the user of the terminal device is in the vehicle-driving state, sending a first message to a server for the server to make the vehicle-driving state of the user noticeable to one or more contact persons of the user to avoid calling disturbance from the one or more contact persons.

According to an aspect of the disclosure, when the user of the terminal device is in a non-driving state, the method includes sending a second message to the server for the server to make the non-driving state of the user noticeable to the one or more contact persons

To determine, at the terminal device, whether the user of the terminal device is in the vehicle-driving state, the method includes determining whether a vehicle-mounted system is connectable with the terminal device using a short distance wireless communication. When the vehicle-mounted system is connectable with the terminal device using the short distance wireless communication, the method includes determining that the user of the terminal device is in the vehicle-driving state.

To determine whether the vehicle-mounted system is connectable with the terminal device using the short distance wireless communication further, in an example, the method includes determining whether the vehicle-mounted system is connectable with the terminal device using the short distance wireless communication with the terminal device. In another example, the method includes determining whether the vehicle-mounted system is connectable with the terminal device using the short distance wireless communication with a wearable device that is connected to the terminal device.

Aspects of the disclosure provide another method for communication, The method includes receiving, at a second terminal device belonging to a second user, an instruction to make a mobile phone communication with a first terminal device belonging to a first user, and querying a server a present state of the first user. The server is configured to maintain a state of the first user and to make the state of the first user accessible to a specific group of contact persons of the first user that include the second user. Then the method includes determining whether the present state is a vehicle-driving state, and when the present state is the vehicle-driving state, triggering a preset operation. In an example, when the present state is a non-driving state, the method includes starting the mobile phone communication with the first terminal device.

To trigger the preset operation, in an example, the method includes generating, by the second terminal device, a signal indicative of the vehicle-driving state of the first user, to inform the second user. Further, in an example, the method includes receiving an update signal from the server that indicative of an update of a non-driving state of the first user, and generating a prompt signal by the second terminal device to inform the second user the non-driving state of the first user.

Aspects of the disclosure provide a device for communication. The device includes a processor and a memory for storing instructions executable by the processor. The processor is configured to determine whether a user of the device is in a vehicle-driving state, and when the user of the device is in the vehicle-driving state, sending a first message to a server for the server to make the vehicle-driving state of the user noticeable to one or more contact persons of the user to avoid calling disturbance from the one or more contact persons.

Aspects of the disclosure provide a device for communication. The device includes a processor and a memory for storing instructions executable by the processor. The processor is configured to receive, at the device belonging to a second user, an instruction to make a mobile phone communication with another device belonging to a first user, and query a server a present state of the first user. The server is configured to maintain a state of the first user and to make the state of the first user accessible to a specific group of users that include the second user. Further, the processor is configured to determine whether the present state is a vehicle-driving state; and when the present state is the vehicle-driving state, trigger a preset operation.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention, and together with the description, serve to explain the principles of the invention.

FIG. 1 is a flow chart illustrating a method for making a call, according to an exemplary embodiment.

FIG. 2 is a flow chart illustrating a method for making a call, according to an exemplary embodiment.

FIG. 3 is a scenario diagram illustrated according to an exemplary embodiment.

FIG. 4 is a scenario diagram illustrated according to an exemplary embodiment.

FIG. 5 is a flow chart illustrating a method for making a call, according to an exemplary embodiment.

FIG. 6 is a flow chart illustrating a method for making a call, according to an exemplary embodiment.

FIG. 7 is a flow chart illustrating a method for making a call, according to an exemplary embodiment.

FIG. 8 is a signaling diagram illustrating a method for making a call, according to an exemplary embodiment.

FIG. 9 is an interface diagram illustrated according to an exemplary embodiment.

FIG. 10 is a block diagram illustrating a device for making a call, according to an exemplary embodiment.

FIG. 11 is a block diagram illustrating a device for making a call, according to an exemplary embodiment.

FIG. 12 is a block diagram illustrating a device for making a call, according to an exemplary embodiment.

FIG. 13 is a block diagram illustrating a device for making a call, according to an exemplary embodiment.

FIG. 14 is a block diagram illustrating a device for making a call, according to an exemplary embodiment.

FIG. 15 is a block diagram illustrating a device for making a call, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. instead, they are merely examples of devices and methods consistent with some aspects related to the invention as recited in the appended claims.

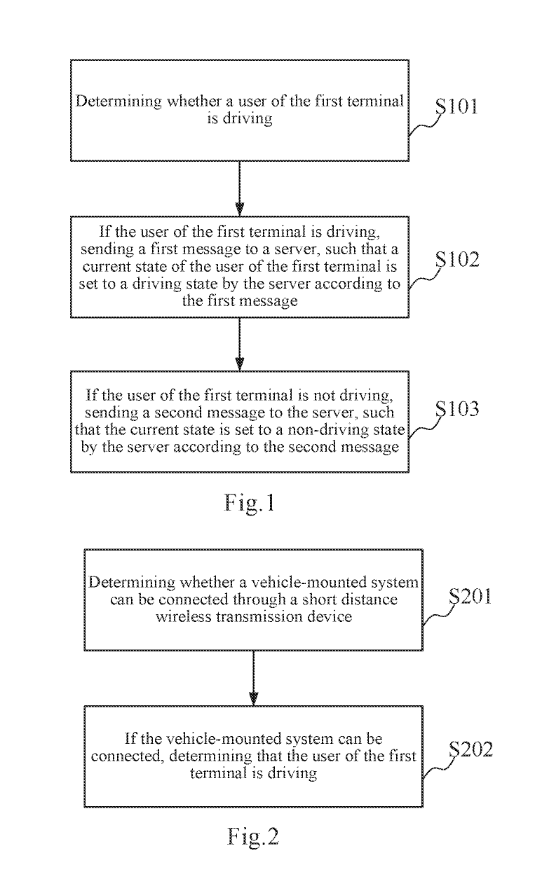

FIG. 1 is a flow chart illustrating a method for making a call, according to an exemplary embodiment. The method may be applied in a first terminal, such as a mobile phone, a tablet computer, etc. The first terminal is a called terminal, and a user of the first terminal is a called user or a listener.

Referring, to FIG. 1, the method may include the following steps.

In step S101, whether a user of the first terminal is driving is determined.

In the specific implementation, the first terminal may determine whether the user of the first terminal is currently driving, in many ways, and the present embodiment is not limited to these ways. For example, the first terminal may determine whether the user is driving by judging whether a position of the first terminal and a position of a car of the user are overlapped, and the like. These ways may be used here without departing from the spirit and the protection scope of the present disclosure.

In step 102, if the user of the first terminal is driving, a first message is sent to a server, such that a current state of the user of the first terminal is set to a driving state by the server according to the first message.

The server may store the current state of the user of the first terminal, for other users to query. In this way, when calling to the user of the first terminal, terminals of the other users may query the current state of the user of the first terminal firstly, and if the current state is the driving state, a prompt may be provided.

As an example, in the specific implementation, the current state of the user of the first terminal may be realized in a form of a cloud card. The cloud card is an electronic card stored in a cloud server by the user. Since a cloud sharing function can be realized, the electronic card is referred to as “the cloud card”.

Furthermore, in order to protect the privacy, the current state of the user of the first terminal user is usually only opened to specified users, for example, the specified users may be friends in a chat software of the user of the first terminal, or contacts in an address book of the first terminal, and the like.

In step S103, if the user of the first terminal is not driving, a second message is sent to the server, such that the current state is set to a non-driving state by the server according to the second message.

In this way, when the terminals of the other users query the current state of the user of the first terminal again, and if it is found that the current state is not the driving, state, the prompt may also be provided.

Referring to FIG. 2, in the present embodiment or some other embodiments of the present disclosure, the determining whether the user of the first terminal is driving may include the following steps.

In step S201, whether the first terminal can connect to a vehicle-mounted system through a short distance wireless transmission device is determined.

For example, the short distance wireless transmission device may be a Bluetooth module.

In step S202, if the first terminal can connect to the vehicle-mounted system, the user of the first terminal is driving is determined.

For example, if the Bluetooth module in the mobile phone can be connected to the vehicle-mounted system, it means that the user is in the car, and it may be further inferred that the user is driving. Of course, the present embodiment will not discuss the special case that the user is only a passenger in the car rather than a driver and the like.

As an example, the short distance wireless transmission device may he installed in the first terminal, or may be installed in a wearable device connected to the first terminal.

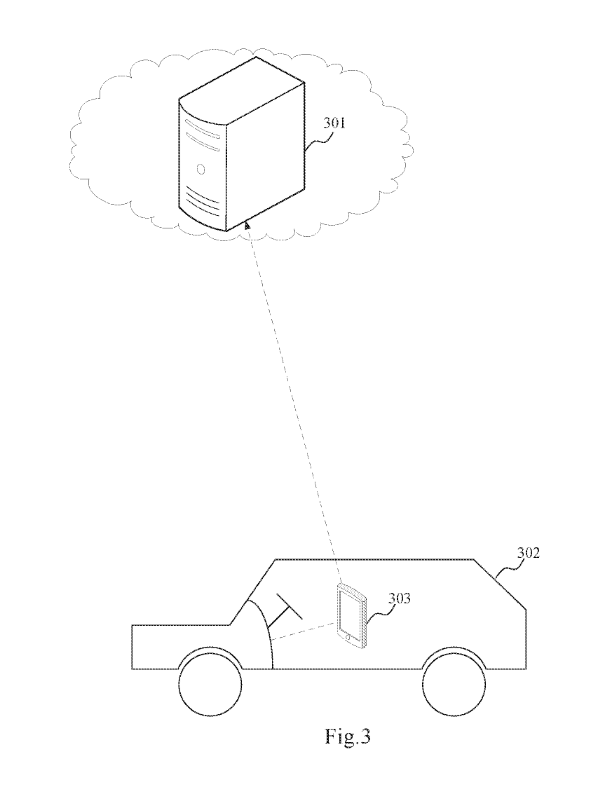

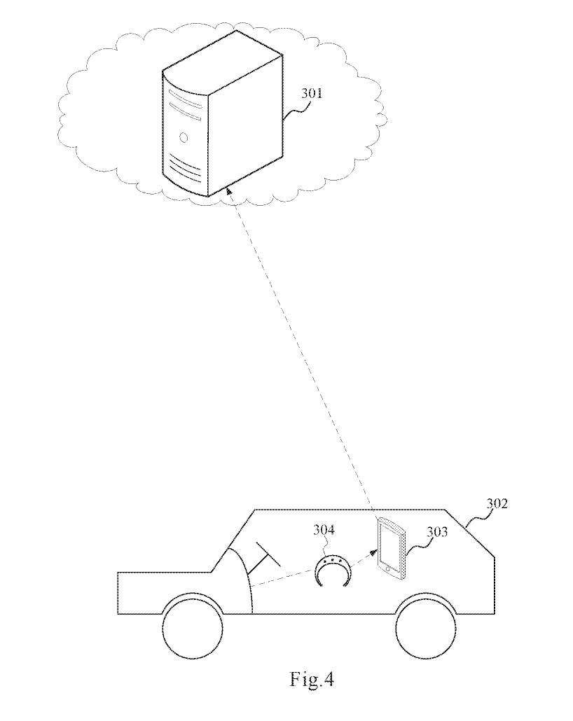

Referring to FIG. 3 and FIG. 4, taking that the first terminal is a mobile phone and the wearable device is a bracelet as an example. In FIG. 3, a mobile phone 303 finds that it can connect to a vehicle-mounted system of a car 302 via Bluetooth, then a message is sent to a server 301, to inform the server that the user is currently driving. In FIG. 4, a bracelet 304 finds that it can connect to the vehicle-mounted system of the car 302 via Bluetooth, then it is reported to the mobile phone 303, then the message is sent to the server 302 by the mobile phone 303, to inform the server that the user is currently driving.

In the related arts, the caller usually does not know that the listener is driving, and thereby the telephone interference to the listener is unavoidable. However, in the above embodiments, the terminal device of the listener may know that the listener is driving, then inform the cloud server to update the state of the listener. In this way, when the caller makes a call, a mobile phone of the caller may query the state of the listener from the server firstly, and if the listener is currently driving, the mobile phone of the caller sends a reminder to the caller, and thus the interference to the listener is avoided, and thereby the safety of the listener in driving is ensured,

FIG. 5 is a flow chart illustrating a method for making a call, according to an exemplary embodiment. The method may be applied in a second terminal, such as a mobile phone, a tablet computer, etc. The second terminal is a calling terminal, and a user of the second terminal is a calling user or a caller.

Referring to FIG. 5, the method may include the following steps.

In step S501, when calling a first terminal, the second terminal queries a current state of a user of the first terminal from a server, wherein the current state is opened to specified users, and a user of the second terminal belongs to the specified users.

The server may store the current state of the user of the first terminal, for other users to query. In this way, when calling to the user of the first terminal, terminals of the other users may query the current state of the user of the first terminal firstly, and if the current state is the driving state, a prompt may be provided.

As an example, in the specific implementation, the current state of the user of the first terminal may be realized in a form of a cloud card. The cloud card is an electronic card stored in a cloud server by the user. Since a cloud sharing function can be realized, the electronic card is referred to as “the cloud card”.

Furthermore, in order to protect the privacy, the current state of the user of the first terminal user is usually only opened to specified users, for example, the specified users may be friends in a chat software of the user of the first terminal, or contacts in an address book of the first terminal, and the like.

In step S502, whether the current state is a driving state is determined.

In step S503, if the current state is the driving state, a preset operation is triggered.

In the present embodiment or some other embodiments of the present disclosure, the preset operation may include:

sending a reminder that the user of the first terminal is driving,

Furthermore, the preset operation may include: cancelling the present call, or sending in a form of a short message, and the like. The present embodiment is not limited thereto.

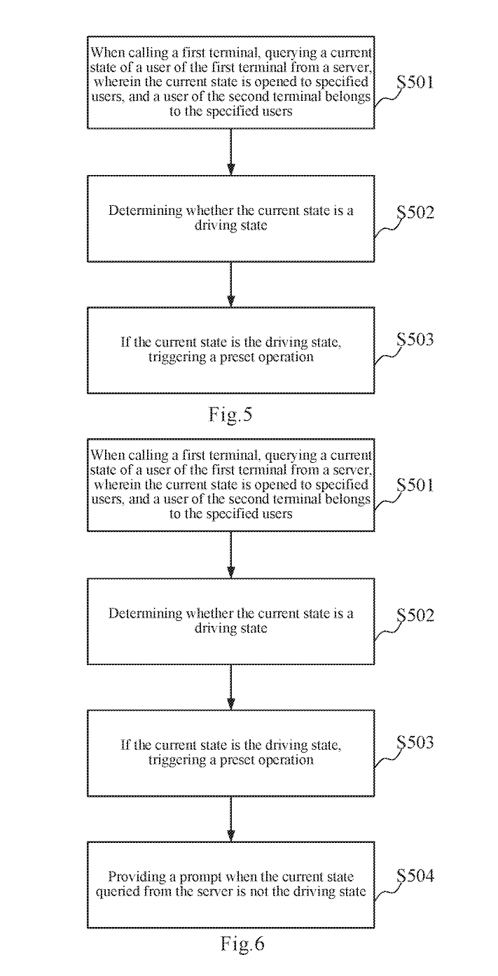

Referring to FIG. 6, in the present embodiment or some other embodiments of the present disclosure, after triggering the preset operation, the method may further include the following step.

In step S504, a prompt is provided when the current state queried from the server is not the driving state.

In this way, after seeing the prompt, the caller may make a call to the listener again.

In the above embodiments, the terminal device of the listener may know that the listener is driving, then inform the cloud server to update the state of the listener. In this way, when the caller makes a call, a mobile phone of the caller may query the state of the listener from the server firstly, and if the listener is currently driving, the mobile phone of the caller sends a reminder to the caller, and thus the interference to the listener is avoided, and thereby the safety of the listener in driving is ensured.

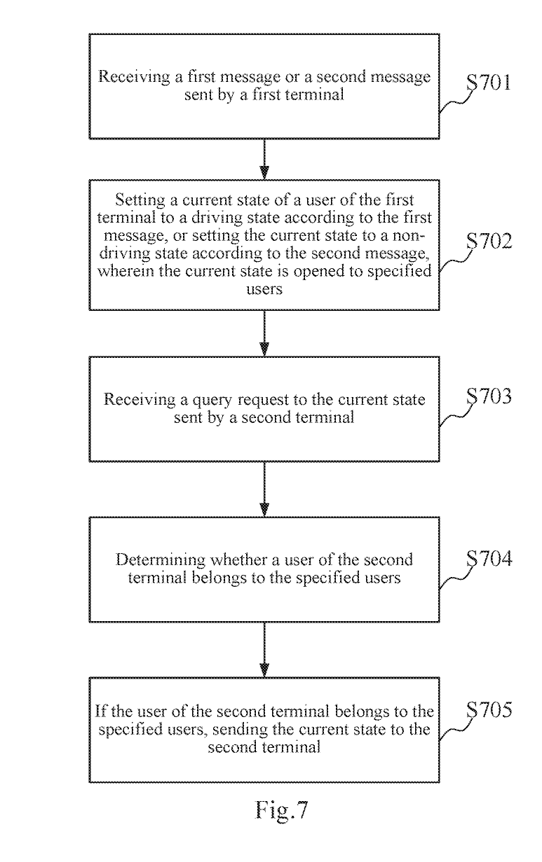

FIG. 7 is a flow chart illustrating a method for making a call, according to an exemplary embodiment. The method may be applied in a server. Referring to FIG. 7, the method may include the following steps.

In step S701, a first message or a second message sent by a first terminal is received.

In step S702, a current state of a user of the first terminal is set to a driving state according to the first message, or the current state is set to a non-driving state according to the second message, wherein the current state is opened to specified users.

The server may store the current state of the user of the first terminal, for other users to query. In this way, when calling to the user of the first terminal, terminals of the other users may query the current state of the user of the first terminal firstly, and if the current state is the driving state, a prompt may be provided.

As an example, in the specific implementation, the current state of the user of the first terminal may be realized in a form of a cloud card, The cloud card is an electronic card stored in a cloud server by the user. Since a cloud sharing function can be realized, the electronic card is referred to as “the cloud card”.

Furthermore, in order to protect the privacy, the current state of the user of the first terminal user is usually only opened to specified users, for example, the specified users may be friends in a chat software of the user of the first terminal, or contacts in an address book of the first terminal, and the like.

In step S703, a query request to the current state sent by a second terminal is received.

In step S704, whether a user of the second terminal belongs to the specified users is determined.

In step S705, if the user of the second terminal belongs to the specified users, the current state is sent to the second terminal.

In the above embodiments, the terminal device of the listener may know that the listener is driving, then inform the cloud server to update the state of the listener. In this way, when the caller makes a call, a mobile phone of the caller may query the state of the listener from the server firstly, and if the listener is currently driving, the mobile phone of the caller sends a reminder to the caller, and thus the interference to the listener is avoided, and thereby the safety of the listener in driving is ensured.

Hereinafter, the aspects of the present disclosure will be further described by combining a specific scenario.

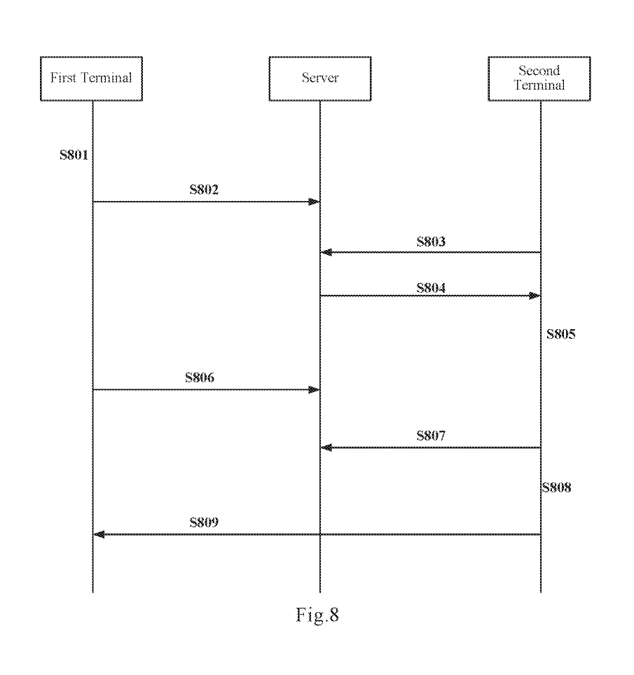

FIG. 8 is a signaling diagram illustrating a method for making a call, according to an exemplary embodiment.

In step S801, a first terminal finds that it can connect to a vehicle-mounted system via Bluetooth, then it infers that a user of the first terminal is driving.

In step S802, the first terminal sends a first message to a server, such that a cloud card of the user of the first terminal is set to a driving state by the server.

In step S803, before making a call to the user of the first terminal, a second terminal queries the cloud card of the user of the first terminal from the server firstly.

In step S804, the server sends the cloud card of the user of the first terminal to the second terminal.

In step S805, the second terminal finds that the user of the first terminal is driving, then provides a notification to a user of the second terminal.

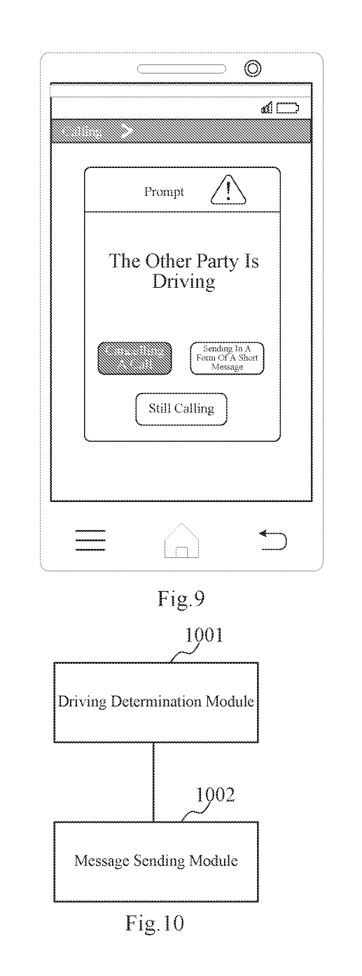

Furthermore, in addition to the notification, several options may be provided for the user of the second terminal to select, as an example shown in FIG. 9. In FIG. 9, after seeing the notification, the user may make a choice among “cancelling a call”, “sending in a form of a short message” and “still calling”.

In step S806, the first terminal finds that a Bluetooth connection with the vehicle-mounted system is disconnected, then it infers that the user of the first terminal is not driving.

In step S807, the first terminal sends a second message to the server, such that the cloud card of the user of the first terminal is set to a non-driving state.

In step S808, the second terminal queries the cloud card of the user of the first terminal again, finds that the user of the first terminal is not driving, then informs it to the user of the second terminal.

In step S809, the user of the second terminal makes the call to the user of the first terminal again, and finally the call is realized.

In the above embodiments, the terminal device of the listener may know that the listener is driving, then inform the cloud server to update the state of the listener. In this way, when the caller makes a call, a mobile phone of the caller may query the state of the listener from the server firstly, and if the listener is currently driving, the mobile phone of the caller sends a reminder to the caller, and thus the interference to the listener is avoided, and thereby the safety of the listener in driving is ensured.

Embodiments of devices of the present disclosure are described hereinafter, which may be used for performing embodiments of methods of the present disclosure. For the details not described in the embodiments of devices of the present disclosure, please refer to the embodiments of methods of the present disclosure.

FIG. 10 is a block diagram illustrating a device for making a call, according to an exemplary embodiment. The device may be applied in a first terminal. Referring to FIG. 10, the device may include:

a driving determination module 1001 configured to determine whether a user of the first terminal is driving, and if the user of the first terminal is driving, a message sending module 1002 is triggered; and

the message sending module 1002 configured to send a first message to a server, such that a current state of the user of the first terminal is set to a driving state by the server according to the first message, and if the user of the first terminal is not driving, send a second message to the server, such that the current state is set to a non-driving state by the server according to the second message, wherein the current state is opened to specified users.

In the present embodiment or some other embodiments of the present disclosure, the driving determination module 1001 is configured to: determine whether a vehicle-mounted system can be connected through a short distance wireless transmission device; and if the vehicle-mounted system can be connected, determine that the user of the first terminal is driving.

In the present embodiment or some other embodiments of the present disclosure, the short distance wireless transmission device is installed in the first terminal, or is installed in a wearable device connected to the first terminal.

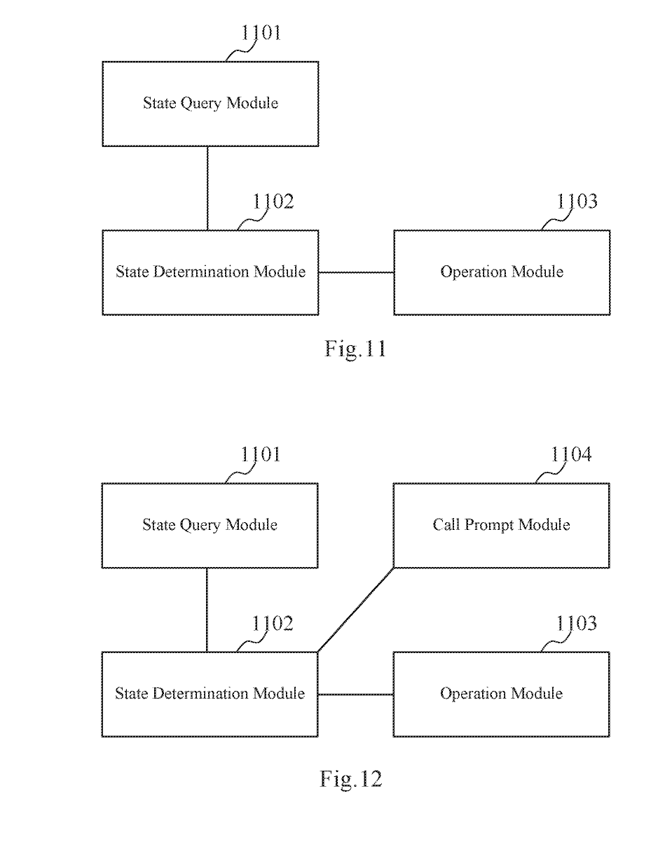

FIG. 11 is a block diagram illustrating a device for making a call, according to an exemplary embodiment. The device may be applied in a second terminal. Referring to FIG. 11, the device may include:

a state query module 1101 configured to, when calling a first terminal, query a current state of a user of the first terminal from a server, wherein the current state is opened to specified users, and a user of the second terminal belongs to the specified users;

a state determination module 1102 configured to determine whether the current state is a driving state, and if the current state is the driving state, an operation module 1103 is triggered; and

the operation module 1103 configured to perform a preset operation.

In the present embodiment or some other embodiments of the present disclosure, the preset operation includes:

sending a reminder that the user of the first terminal is driving,

Referring to FIG. 12, in the present embodiment or some other embodiments of the present disclosure, the device may further include:

a call prompt module 1104 configured to provide a prompt when the current state queried from the server is not the driving state.

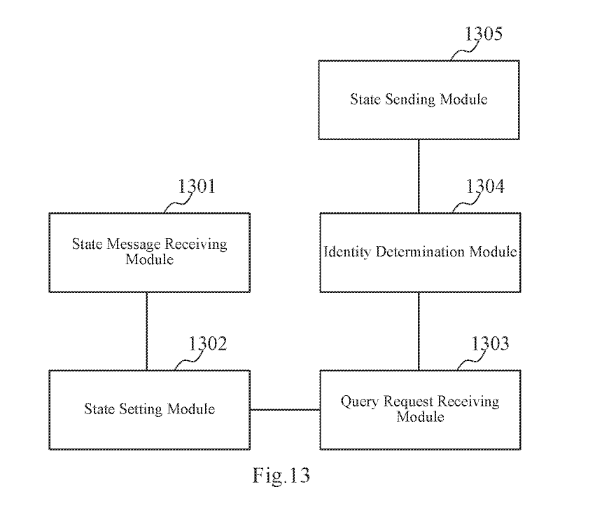

FIG. 13 is a block diagram illustrating a device for making a call, according to an exemplary embodiment. The device may be applied in a server. Referring to FIG. 13, the device may include:

a state message receiving module 1301 configured to receive a first message or a second message sent by a first terminal;

a state setting module 1302 configured to set a current state of a user of the first terminal to a driving state according to the first message, or set the current state to a non-driving state according to the second message, wherein the current state is opened to specified users;

a query request receiving module 1303 configured to receive a query request to the current state sent by a. second terminal;

an identity determination module 1304 configured to determine whether a user of the second terminal belongs to the specified users, and if the user of the second terminal belongs to the specified users, a state sending module is triggered; and

the state sending module 1305 configured to send the current state to the second terminal.

In the above embodiments, the terminal device of the listener may know that the listener is driving, then inform the cloud server to update the state of the listener. In this way, when the caller makes a call, a mobile phone of the caller may query the state of the listener from the server firstly, and if the listener is currently driving, the mobile phone of the caller sends a reminder to the caller, and thus the interference to the listener is avoided, and thereby the safety of the listener in driving is ensured.

With respect to the devices in the above embodiments, the specific manners for performing operations for individual modules therein and technical effects have been described in detail in the embodiments regarding the methods, which will not be elaborated herein.

The present disclosure further discloses a device for making a call, including:

a processor; and

a memory for storing instructions executable by the processor;

wherein the processor is configured to:

determine whether a user of the first terminal is driving;

if the user of the first terminal is driving, send a first message to a server, such that a current state of the user of the first terminal is set to a driving state by the server according to the first message; and

if the user of the first terminal is not driving, send a second message to the server, such that the current state is set to a non-driving state by the server according to the second message.

The present disclosure further discloses a non-transitory computer-readable storage medium having stored therein instructions that, when executed by the processor of the first terminal, causes the first terminal to perform the method for making a call, the method including:

determining whether a user of the first terminal is driving;

if the user of the first terminal is driving, sending a first message to a server, such that a current state of the user of the first terminal is set to a driving state by the server according to the first message; and

if the user of the first terminal is not driving, sending a second message to the server, such that the current state is set to a non-driving state by the server according to the second message.

The present disclosure further discloses a device for making a call, including:

a processor; and

a memory for storing instructions executable by the processor;

wherein the processor is configured to:

when calling a first terminal, query a current state of a user of the first terminal from a server, wherein the current state is opened to specified users, and a user of the second terminal belongs to the specified users;

determine whether the current state is a driving state; and

if the current state is the driving state, trigger a preset operation.

The present disclosure further discloses a non-transitory computer-readable storage medium having stored therein instructions that, when executed by the processor of the second terminal, causes the second terminal to perform the method for making a call, the method including:

when calling a first terminal, querying a current state of a user of the first terminal from a server, wherein the current state is opened to specified users, and a user of the second terminal belongs to the specified users;

determining whether the current state is a driving state; and

if the current state is the driving state, triggering a preset operation.

The present disclosure further discloses a device for making a call, including:

a processor; and

a memory for storing instructions executable by the processor;

wherein the processor is configured to:

receive a first message or a second message sent by a first terminal;

set a current state of a user of the first terminal to a driving state according to the first message, or set the current state to a non-driving state according to the second message, wherein the current state is opened to specified users;

receive a query request to the current state sent by a second terminal;

determine whether a user of the second terminal belongs to the specified users; and

if the user of the second terminal belongs to the specified users, send the current state to the second terminal.

The present disclosure further discloses a non-transitory computer-readable storage medium having stored therein instructions that, when executed by the processor of the server, causes the server to perform the method for making a call, the method including:

receiving a first message or a second message sent by a first terminal;

setting a current state of a user of the first terminal to a driving state according to the first message, or setting the current state to a non-driving state according to the second message, wherein the current state is opened to specified users;

receiving a query request to the current state sent by a second terminal;

determining whether a user of the second terminal belongs to the specified users; and

if the user of the second terminal belongs to the specified users, sending the current state to the second terminal.

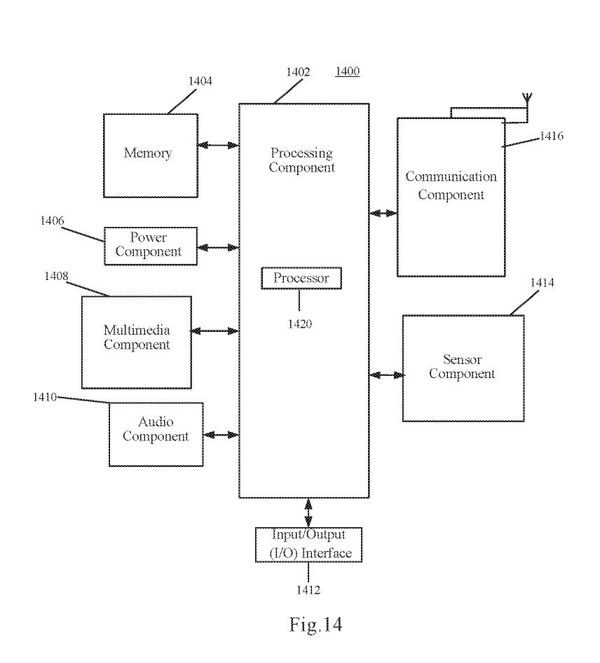

FIG. 14 is a block diagram illustrating a device for making a call, according to an exemplary embodiment. For example, the device 1400 may be a mobile phone, a computer, a digital broadcast terminal, a messaging device, a gaming console, a tablet, a medical device, exercise equipment, a personal digital assistant, and the like.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400,

The multimedia component 1408 includes a screen providing an output interface between the device 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a. period of time and a pressure associated with the touch or swipe action. In some embodiments, the multimedia. component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a. locking button.

The sensor component 1414 includes one or more sensors to provide status assessments of various aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a. wireless network based on a communication standard, such as WiFi, 2G, or 3G, or a combination thereof in one exemplary embodiment, the communication component 1416 receives a broadcast signal or broadcast associated information from an external broadcast management system via a broadcast channel. In one exemplary embodiment, the communication component 1416 further includes a near field communication (NIT) module to facilitate short-range communications. For example, the NFC module may be implemented based on a radio frequency identification (RFID) technology, an infrared data association (IrDA.) technology, an ultra-wideband (MB) technology, a Bluetooth (BT) technology, and other technologies.

In exemplary embodiments, the device 1400 may he implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is al so provided a non-transitory computer-readable storage medium including instructions, such as included in the memory 1404, executable by the processor 1420 in the device 1400, for performing the above-described methods. For example, the non-transitory computer-readable storage medium may be a ROM, a RAM, a CD-ROM, a magnetic tape, a floppy disc, an optical data storage device, and the like.

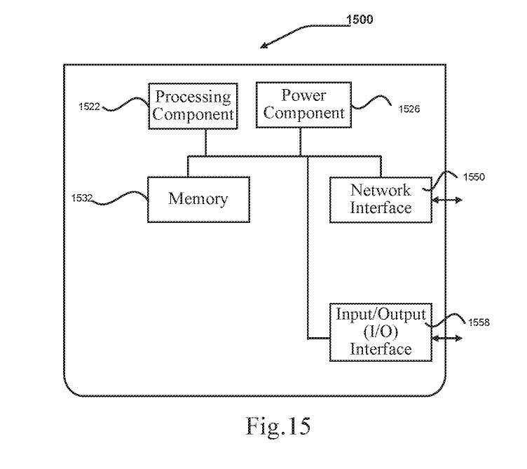

FIG. 15 is a block diagram illustrating a device for making a call, according to an exemplary embodiment. For example, the device 1500 may be provided as a server.

Referring to FIG. 15, the device 1500 includes a processing component 1522 that further includes one or more processors, and memory resources represented by a memory 1532 for storing instructions executable by the processing component 1522, such as application programs. The application programs stored in the memory 1532 may include one or more modules each corresponding to a set of instructions. Further, the processing component 1522 is configured to execute the instructions to perform the solutions for locating a. wearable device at the server side.

The device 1500 may also include a power component 1526 configured to perform power management of the device 1500, wired or wireless network interface(s) 1550 configured to connect the device 1500 to a network, and an input/output (I/O) interface 1558. The device 1500 may operate based on an operating system stored in the memory 1532, such as Windows Server™, Mac OS X™, Unix™, Linux™, FreeBSD™, or the like.

It is noted that the various modules, sub-modules, units and components in the present disclosure can be implemented using any suitable technology. In an example, a module can be implemented using circuitry, such as integrated circuit (IC). In another example, a module can be implemented as a processing circuit executing software instructions.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present invention is not limited to the exact construction that has been described above and illustrated in the accompanying drawings, and that various modifications and changes can be made without departing from the scope thereof It is intended that the scope of the present disclosure only be limited by the appended claims.

What is claimed is:

1. A method for communication comprising:
determining, at a terminal device, whether a user of the terminal device is in a vehicle-driving state; and
when the user of the terminal device is in the vehicle-driving state, sending a first message to a server for the server to make the vehicle-driving state of the user noticeable to one or more contact persons of the user to avoid calling disturbance from the one or more contact persons.

2. The method according to claim 1, further comprising:
when the user of the terminal device is in a non-driving state, sending a second message to the server for the server to make the non-driving state of the user noticeable to the one or more contact persons.

3. The method according to claim I, wherein determining, at the terminal device, whether the user of the terminal device is in the vehicle-driving state comprises:
determining whether a vehicle-mounted system is connectable with the terminal device using a short distance wireless communication; and
when the vehicle-mounted system is connectable with the terminal device using the short distance wireless communication, determining that the user of the terminal device is in the vehicle-driving state.

4. The method according to claim 3, wherein determining whether the vehicle-mounted system is connectable with the terminal device using the short distance wireless communication further comprises at least one of:
determining whether the vehicle-mounted system is connectable with the terminal device using the short distance wireless communication with the terminal device; and
determining whether the vehicle-mounted system is connectable with the terminal device using the short distance wireless communication with a wearable device that is connected to the terminal device.

5. A method for communication comprising:
receiving, at a second terminal device belonging to a second user, an instruction to make a mobile phone communication with a first terminal device belonging to a first user;
querying a server a present state of the first user, the server being configured to maintain a state of the first user and to make the state of the first user accessible to a specific group of contact persons of the first user that include the second user;
determining whether the present state is a vehicle-driving state; and
when the present state is the vehicle-driving state, triggering a preset operation.

6. The method according to claim 5, wherein triggering the preset operation comprises:
generating, by the second terminal device, a signal indicative of the vehicle-driving state of the first user, to inform the second user.

7. The method according to claim 5, further comprising:
receiving an update signal from the server that indicative of an update of a non-driving state of the first user; and
generating a prompt signal by the second terminal device to inform the second user the non-driving state of the first user.

8. The method according to claim 5, further comprising:
when the present state is a non-driving state, starting the mobile phone communication with the first terminal device.

9. A device for communication, comprising:
a processor; and
a memory for storing instructions executable by the processor;
wherein the processor is configured to:
determine whether a user of the device is in a vehicle-driving state; and
when the user of the device is in the vehicle-driving state, sending a first message to a server for the server to make the vehicle-driving state of the user noticeable to one or more contact persons of the user to avoid calling disturbance from the one or more contact persons.

10. The device according to claim 9, wherein the processor is configured to, when the user of the device is in a non-driving state, send a second message to the server for the server to make the non-driving state of the user noticeable to the one or more contact persons

11. The device according to claim 9, wherein the processor is configured to:
determine whether a vehicle-mounted system is connectable with the device using a short distance wireless communication; and
when the vehicle-mounted system is connectable with the device using the short distance wireless communication, determine that the user of the device is in the vehicle-driving state.

12. The device according to claim 11, wherein the processor is configured to perform at least one of:
determining whether the vehicle-mounted system is connectable with the device using the short distance wireless communication with the device; and
determining whether the vehicle-mounted system is connectable with the device using the short distance wireless communication with a wearable device that is connected to the device.

13. A device for communication, comprising:
a processor; and
a memory for storing instructions executable by the processor;
wherein the processor is configured to:
receive, at the device belonging to a second user, an instruction to make a mobile phone communication with another device belonging to a first user;
query a server a present state of the first user, the server being configured to maintain a state of the first user and to make the state of the first user accessible to a specific group of users that include the second user;
determine whether the present state is a vehicle-driving state; and
when the present state is the vehicle-driving state, trigger a preset operation.

14. The device according to claim 10, wherein the processor is configured to:
generate a signal indicative of the vehicle-driving state of the first user to inform the second user.

15. The device according to claim 10, wherein the processor is configured to:
receive an update signal from the server that is indicative of an update of a non-driving state of the first user; and
generate a prompt signal by the device to inform the second user the non-driving state of the first user,

16. The device according to claim 10, wherein the processor is configured to:
when the present state is a non-driving state, start the mobile phone communication with the other device.
